(19) United States
(12) Patent Application Publication
(10) Pub. No.: US 2008/0274352 A1
(43) Pub. Date: Nov. 6, 2008

(54) OPTICAL FILM COMPRISING ANTISTATIC PRIMER AND ANTISTATIC COMPOSITIONS

(75) Inventors: Encai Hao, Woodbury, MN (US); Mark J. Pellerite, Woodbury, MN (US); Marc D. Radcliffe, Newport, MN (US); Lan H. Liu, Rosemount, MN (US); Jeffrey A. Peterson, Lake Elmo, MN (US); Stephen A. Johnson, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/744,318

(22) Filed: May 4, 2007

(51) Int. Cl. B32B 17/10; C08L 81/00

(52) U.S. Cl. 428/339; 524/413; 524/430; 524/500; 524/80; 525/535

(57) ABSTRACT

Optical films are described that comprise an antistatic primer disposed on the substrate and a high refractive index layer disposed on the primer. The primer comprises a sulfopolymer and at least one antistatic agent. The high refractive index layer comprises surface modified inorganic nanoparticles dispersed in a crosslinked organic material. The antistatic agent is preferably selected from conductive inorganic particles, conductive polymer, and mixtures thereof. Also describes are antistatic compositions and surface treated conductive inorganic oxide particles.

### BACKGROUND

U.S. Pat. No. 7,041,365 describes optical constructions that include a static dissipative layer buried within an optical material.

U.S. Pat. Nos. 6,319,594 and 7,014,912 describe low reflective antistatic hardcoat films.

Optical films having a high refractive index layer are also suitable as an intermediate construction in antireflective polymer films (“AR films”). AR films are often constructed of alternating high and low refractive index (“RI”) polymer layers of the correct optical thickness. With regards to visible light, this thickness is on the order of one-quarter of the wavelength of the light to be reflected. The human eye is most sensitive to light around 550 nm. Therefore it is desirable to design the low and high index coating thicknesses in a manner that minimizes the amount of reflected light in this optical range (e.g. 2.5% or lower).

### SUMMARY

It is a common occurrence that the high refractive index layer does not adhere adequately to the light transmissive substrate. In other instances, the refractive index of the substrate in comparison to the high refractive index layer is not suitably matched resulting in the occurrence of optical fringing. The Applicant has found that certain primer compositions can address either one or both of these problems in combination with concurrently providing static dissipating properties.

In one embodiment, an optical article is described comprising a light transmissive substrate; an antistatic primer disposed on the substrate wherein the primer comprises a sulfopolymer and at least one antistatic agent; and a high refractive index layer having an index of refraction of at least 1.60 disposed on the primer. The high refractive index layer comprises surface modified inorganic nanoparticles dispersed in a crosslinked organic material. The antistatic agent is preferably selected from conductive inorganic particles, conductive polymer, and mixtures thereof. For embodiments wherein a light transmissible substrate having a high refractive index such as polyester or polycarbonate, the refractive index of the primer is typically +/−0.05 of the refractive index of both the substrate and the high refractive index layer. For embodiments wherein the substrate and high refractive index layer differ in refractive index by at least +/−0.10, the antistatic primer preferably has an intermediate refractive index.

In one aspect, the antistatic primer comprises conductive inorganic particles having a refractive index of at least 1.90.

In another embodiment, an antistatic composition is described comprising a sulfopolymer, a conductive polymer, and inorganic oxide particles having a refractive index greater than the sulfopolymer wherein the antistatic primer has a refractive index of at least 1.60. The inorganic oxide particles are typically non-conductive such as tin oxide, titania, and zirconia nanoparticles.

In another embodiment, an antistatic composition is described comprising a sulfopolymer and conductive inorganic oxide particles having a surface treatment consisting of a polar organic compound.

In yet another embodiment, conductive inorganic oxide particles are described having a surface treatment comprising an amino alcohol compound.

In each of these embodiments, the optical film or antistatic layer has a static charge decay time of less than 0.5 seconds.

### BRIEF DESCRIPTION OF THE DRAWINGS

FIG. 1 is perspective view of an article having an optical display.

FIG. 2 is a sectional view of the article of FIG. 1 taken along line 2-2 illustrating an embodied antireflective film having a primer and high refractive index layer.

FIG. 3 is a sectional view of the article of FIG. 1 taken along line 2-2 illustrating an embodied antireflective film comprising a low refractive index layer.

FIG. 4 is the reflection spectra of a polyester film comprising three different primers and a high refractive index layer disposed on the primer.

FIG. 5 is the reflection spectra of antireflective films comprising three different primers, a high refractive index layer disposed on the primer, and a low refractive index layer disposed on the high refractive index layer.

### DETAILED DESCRIPTION OF PREFERRED EMBODIMENTS OF THE INVENTION

Presently described are optical (e.g. film) articles comprising an antistatic primer layer and a high refractive index (e.g. hardcoat) layer. Also described are antistatic compositions suitable for use as a primer or as an antistatic layer for other uses.

The primer comprises at least one sulfopolymer in combination with at least one antistatic agent. Preferred antistatic agents include conductive inorganic oxide particles and/or conductive polymer.

Although the term “conductive” is often used in the industry to refer to “static dissipative”, these terms are not synonymous. Specifically, a conductive material coating is considered to have a surface resistivity up to 1×10⁵ ohms/sq.; whereas an antistatic material coating typically has a surface resistivity up to 1×10¹² ohms/sq. These terms are generally used to describe materials having a conductive or antistatic component or agent on an exposed surface of the material. Optical articles having an antistatic layer “buried” between optical layers having no antistatic properties may be made such that the optical article is antistatic, even though the articles exhibit higher levels of surface resistivity. Furthermore, the static decay times can be maintained even with these high surface resistivity values.

The light transmissive substrate having the antistatic layer disclosed herein can exhibit a surface resistivity of at least about 1×10⁷, 1×10⁸, 1×10⁹, or 1×10¹⁰ ohms/sq, yet maintain their antistatic properties. In addition, the optical articles disclosed herein may exhibit static decay times of less than about 2 seconds, for example, less than 0.1 seconds. The surface resistivity of the optical (e.g. film) articles and antireflective (e.g. film) articles can be higher.

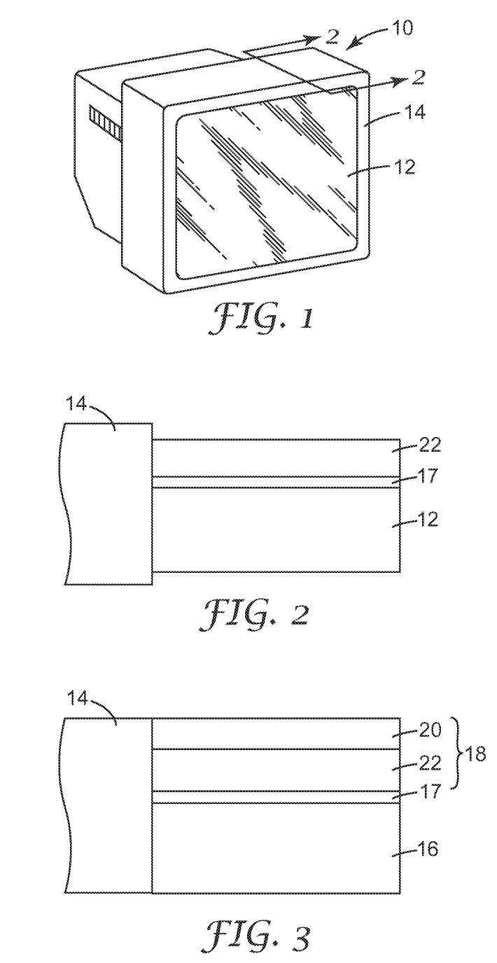

The antistatic primer, high refractive index layer, and low refractive index layer (for antireflective films) can be applied to a variety of film materials which can then be applied to the surface of an optical article such as a display. Alternatively, the antistatic primer, high refractive index layer, and low refractive index layer can be applied directly to the surface of various optical articles. These constructions will be further described with reference to FIGS. 1 and 2, an illustrative (e.g. computer monitor) optical article, and FIG. 3, an illustrative antireflective film.

FIG. 1 is a perspective view of an article (here a computer monitor 10) having an optical display 12 coupled within a housing 14. The optical display comprises a light transmissive substrate 12 through which a user can view (e.g. illuminated) text, graphics, or other displayed information.

With reference to FIG. 2, the optical display 12 can include an antistatic primer 17 disposed on a light transmissive substrate 12 and a high refractive index hardcoat 22 disposed on the antistatic primer.

With reference to FIG. 3, the optical display 12 can include an antistatic primer 17 disposed on a light transmissive film 16, a high refractive index layer 22 disposed on the primer, and a low refractive index layer 20. Low refractive index layer 20 is typically a surface layer exposed to the environment, as depicted in FIG. 2.

The combination of high and low refractive index layer forms an antireflective film 18. The high refractive index layer 22 has a refractive index of at least about 1.60, 1.61, 1.62, 1.63, 1.64, 1.65, 1.66, 1.67, 1.68, 1.67, 1.68, or 1.70. The maximum refractive index of the high index layer is typically no greater than about 1.75 for coatings having high refractive index inorganic nanoparticles dispersed in a crosslinked organic material. The low refractive index layer 20 has a refractive index less than a high refractive index layer. The difference in refractive index between the high refractive index layer and low refractive index layer is typically at least 0.10, or 0.15, or 0.2 or greater. The low refractive index layer typically has a refractive index of less than about 1.5, more typically of less than about 1.45, and even more typically less than about 1.42. The minimum refractive index of the low index layer is generally at least about 1.35.

Antireflective films preferably have an average reflectance of less than 3%, 2%, or 1% at 450 nm to 650 nm as measured with a spectrophotometer as described in the examples.

The optical film or antireflective film may comprise other layers. A permanent or removable grade adhesive composition may be provided on the opposite side of the light transmissive (e.g. film) substrate. The pressure sensitive adhesive layer is typically in contact with a removable release liner. During application of an optical film to a display surface, the release liner is removed so the optical film article can be adhered to the display surface.

In each of these embodiments, the light transmissive substrate can be the display panel 12 or a light transmissive film substrate 16. The (e.g. antireflective) optical films described herein typically have a transmission of at least 80%, at least 85%, and preferably at least 90%.

Both transparent (e.g. gloss) and matte light transmissive substrates 12 and 16 are employed in display panels. For most applications, the substrate thickness is preferably less than about 0.5 mm, and more preferably about 0.02 to about 0.2 mm. The display substrate 12 may comprise or consist of any of a wide variety of non-polymeric materials, such as glass. The display substrate 12 or the light transmissive film 16 typically comprise various thermoplastic and crosslinked polymeric materials. Preferred film materials include polyethylene terephthalate (PET), (e.g. bisphenol A) polycarbonate, cellulose (tri)acetate, poly(methyl methacrylate), and polyolefins such as biaxially oriented polypropylene. In addition, the substrate may comprise a hybrid material, having both organic and inorganic components. The polymeric material can be formed into a film using conventional filmmaking techniques such as by extrusion and optional uniaxial or biaxial orientation of the extruded film. The substrate can be treated to improve adhesion between the substrate and the adjacent layer, e.g., chemical treatment, corona treatment such as air or nitrogen corona, plasma, flame, or actinic radiation.

The optical (e.g. film) articles described herein comprise an antistatic primer composition disposed on a light transmissive substrate and a high refractive index layer disposed on the primer. The antistatic compositions comprise at least one sulfopolymer and at least one antistatic agent such as one or more conductive polymers and/or antistatic particles.

A wide variety of sulfopolymers can be used in the antistatic compositions including sulfopolyesters, ethylenically-unsaturated sulfopolymers, sulfopolyurethanes, sulfopolyurethane/polyureas, sulfopolyester polyols, and sulfopolyols. Such sulfopolymers are described in U.S. Pat. No. 5,427,835; incorporated herein by reference.

Also useful are commercially available sulfonate-containing polymers such as poly(sodium styrene sulfonate) available from Polyscience, Inc., Warrington, Pa., and alkylene oxide-co-sulfonate-containing polyester (AQ™ resins, Eastman Chemical, Kingsport, Tenn.).

The sulfopolymers are generally water dispersible and thus can be used as the polymeric binder of a water-based coating composition.

In one aspect, the sulfopolymer is a non-crystalline sulfopolyester having a low melting point (below 100° C.). Such sulfopolyesters are described in U.S. Pat. Nos. 3,734,874; 3,779,993; 4,052,368; 4,104,262; 4,304,901; and 4,330,588.

In general, sulfopolyesters of this type may be described by the following formula:

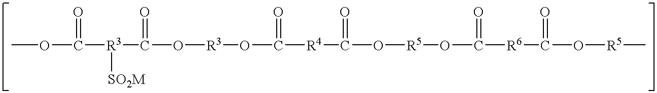

where

M can be an alkali metal cation such as sodium, potassium, or lithium; or suitable tertiary and quaternary ammonium cations having 0 to 18 carbon atoms, such as ammonium, hydrazonium, N-methylpyridinium, methylammonium, butylammonium, diethylammonium, triethylammonium, tetraethylammonium, and benzyltrimethylammonium.

R³ can be an arylene or aliphatic group incorporated in the sulfopolyester by selection of suitable sulfo-substituted dicarboxylic acids such as sulfoalkanedicarboxylic acids including sulfosuccinic acid, 2-sulfoglutaric acid, 3-sulfoglutaric acid, and 2-sulfododecanedioic acid; and sulfoarenedicarboxylic acids such as 5′-sulfoisophthalic acid, 2-sulfoterephthalic acid, 5-sulfonapthalene-1,4-dicarboxylic acid; sulfobenzylmalonic acid esters such as those described in U.S. Pat. No. 3,821,281; sulfophenoxymalonate such as described in U.S. Pat. No. 3,624,034; and sulfofluorenedicarboxylic acids such as 9,9-di-(2′-carboxyethyl)-fluorene-2-sulfonic acid. Corresponding lower alkyl carboxylic esters of 4 to 12 carbon atoms, halides, anhydrides, and sulfo salts of the above sulfonic acids can also be used.

R⁴ can be optionally incorporated in the sulfopolyester by the selection of one or more suitable arylenedicarboxylic acids, or corresponding acid chlorides, anhydrides, or lower alkyl carboxylic esters of 4 to 12 carbon atoms. Suitable acids include the phthalic acids (orthophthalic, terephthalic, isophthalic), 5-t-butylisophthalic acid, naphthalic acids (e.g., 1,4- or 2,5-napthalene dicarboxylic), diphenic acid, oxydibenzoic acid, anthracene dicarboxylic acids, and the like. Examples of suitable esters or anhydrides include dimethyl isophthalate or dibutyl terephthalate, and phthalic anhydride.

R⁵ can be incorporated in the sulfopolyester by the selection of one or more suitable diols including straight or branched chain alkylenediols having the formula HO(CH₂)_{c}OH in which c is an integer of 2 to 12 and oxaalkylenediols having a formula H—(OR⁵)^{d}—OH in which R⁵ is an alkylene group having 2 to 4 carbon atoms and d is an integer of 1 to 6, the values being such that there are no more than 10 carbon atoms in the oxaalkylenediol. Examples of suitable diols include ethyleneglycol, propyleneglycol, 1,5-pentanediol, 1,6-hexanediol, 1,8-octanediol, 1,10-decanediol, 2,2-dimethyl-1,3-propanediol, 2,2-diethyl-1,3-propanediol, 3-methyl-1,5-pentanediol, diethyleneglycol, dipropyleneglycol, diisopropyleneglycol, and the like. Also included are suitable cycloaliphatic diols such as 1,4-cyclohexanedimethanol, 1,3-cyclohexanedimethanol, and the like. Suitable polyester or polyether polyols may used such as polycaprolactone, polyneopentyl adipate, or polyethyleneoxide diols up to 4000 in molecular weight, and the like; generally these polyols are used in conjunction with lower molecular weight diols such as ethylene glycol if high molecular weight polyesters are desired.

R⁶ can be incorporated in the sulfopolyester by the selection of suitable aliphatic or cycloaliphatic dicarboxylic acids or corresponding acid chlorides, anhydrides or ester derivatives; such as acids having the formula HOOC(CH₂)ₑCOOH, wherein e is an integer having an average value of 2 to 8 (e.g. succinic acid, adipic acid, maleic acid, glutaric acid, suberic acid, sebacic acid, and the like). Suitable cycloaliphatic acids include cyclohexane-1,4-dicarboxylic acid, and the like.

The sulfopolyesters of this invention can be prepared by standard techniques, typically involving the reaction of dicarboxylic acids (or diesters, anhydrides, etc. thereof) with monoalkylene glycols and/or polyols in the presence of acid or metal catalysts (e.g., antimony trioxide, zinc acetate, p-toluenesulfonic acid, etc.), utilizing heat and pressure as desired. Normally, an excess of the glycol is supplied and removed by conventional techniques in the later stages of polymerization. When desired, a hindered phenol antioxidant may be added to the reaction mixture to protect the polyester from oxidation. To ensure that the ultimate polymer will contain more than 90 mole % of the residue of monoalkylene glycols and/or polyols, a small amount of a buffering agent (e.g. sodium acetate, potassium acetate, etc.) is added. While the exact reaction mechanism is not known with certainty, it is thought that the sulfonated aromatic dicarboxylic acid promotes the undesired polymerization of the glycol per se and that this side reaction is inhibited by a buffering agent.

The (e.g. sulfopolyester) sulfopolymer is generally mixed with a crosslinker prior to adding the antistatic agent. Suitable crosslinkers include carbodiimide crosslinkers, organosilane crosslinkers, epoxy crosslinkers, aziridine crosslinkers, and blends thereof. The concentration of crosslinker is typically at least about 1 wt-%, 2 wt-% or 3 wt-% based on polymer solids. The concentration of crosslinker is generally less than 20 wt-%, and in some embodiments no greater than about 15 wt-% based on polymer solids. An illustrative carbodiimide crosslinker is available from Stahl Chemicals under the trade designation “XR-5577”. An illustrative polyfunctional aziridine crosslinker is commercially available from DSM NeoResins under the trade designation “Crosslinker CX-100”. Another illustrative polyfunctional aziridine crosslinker is commercially available from Hoechst Celanese under the trade designation “XAMA-7”. An illustrative organosilane crosslinker is γ-glycidoxypropyltrimethoxysilane, commercially available from Aldrich.

Aziridine cross-linkers such as CX-100 and XAMA-7 can improve adhesion with the high refractive index (e.g. hardcoat) layer. Carbodiimide crosslinkers not only improve adhesion with high refractive index layer, but also provide more stable coating formulations and better compatibility with conductive polymer antistatic additives such as Baytron P than that of aziridine crosslinkers. The epoxy-organosilane crosslinker was found to be preferred for cellulose (tri)acetate film material.

The (e.g. sulfopolyester) sulfopolymer is combined with one or more antistatic agents in an amount sufficient to provide that static dissipative properties previously described. For nanoparticle antistats, the antistatic agent is present in an amount of at least 20 wt-%. For conducting inorganic oxide nanoparticles, levels can be up to 80 wt % solids for refractive index modification. When a conductive polymer antistat is employed, it is generally preferred to employ as little as possible due to the strong absorption of the conductive polymer in the visible region. Accordingly, the concentration is generally no greater than 20 wt-% solid, and preferably less than 15 wt-%. In some embodiments the amount of conductive polymer ranges from 2 wt-% to 5 wt-% solids of the dried antistatic layer.

The thickness of the antistatic primer layer is typically at least 20 nm and generally no greater than 300 nm to 400 nm. Generally, only a sufficient amount of primer is applied to provide adequate adhesive in combination with the static dissipative properties. Thickness of 40 nm to 200 nm can be preferred. Higher thicknesses can also be used as desired.

In some embodiments, the antistatic primer composition comprises at least one conductive polymer as an antistatic agent. Various conductive polymers are known. Examples of useful conductive polymers include polyaniline and derivatives thereof, polypyrrole, and polythiophene and its derivatives. One particularly suitable polymer is poly(ethylenedioxythiophene) (PEDOT) such as poly(ethylenedioxythiophene) doped with poly(styrenesulfonic acid)(PEDOT:PSS) commercially available from H. C. Starck, Newton, Mass. under the trade designation “BAYTRON P”. This conductive polymeric can be added at low concentrations to sulfopolyester dispersions to provide antistatic compositions that provided good antistatic performance in combination with good adhesion particularly to polyester and cellulose acetate substrates.

In other embodiments, the antistatic primer composition comprises conductive metal-containing particles, such as metals or semiconductive metal oxides. Such particles may also be described as nanoparticles having a particle size or associated particle size of greater than 1 nm and less than 200 nm. Various granular, nominally spherical, fine particles of crystalline semiconductive metal oxides are known. Such conductive particles are generally binary metal oxides doped with appropriate donor heteroatoms or containing oxygen deficiencies. Suitable conductive binary metal oxides may comprise: zinc oxide, titania, tin oxide, alumina, indium oxide, silica, magnesia, zirconia, barium oxide, molybdenum trioxide, tungsten trioxide, and vanadium pentoxide. Preferred doped conductive metal oxide granular particles include Sb-doped tin oxide, Al-doped zinc oxide, In-doped zinc oxide, and Sb-doped zinc oxide.

Various antistatic particles are commercially available as water-based and solvent-based dispersions. Antimony tin oxide (ATO) nanoparticle dispersions that can be used include a dispersion available from Air Products under the trade designation “Nano ATO S44A” (25 wt-% solids, water), 30 nm and 100 nm (20 wt-% solids, water) dispersions available from Advanced Nano Products Co. Ltd. (ANP), 30 nm and 100 nm ATO IPA sols (30 wt-%) also available from ANP, a dispersion available from Keeling & Walker Ltd under the trade designation “CPM10C” (19.1 wt-% solids), and a dispersion commercially available from Ishihara Sangyo Kaisha, Ltd under the trade designation “SN-100 D” (20 wt-% solids). Further, an antimony zinc oxide (AZO) IPA sol (20 nm, 20.8 wt-% solids) is available from Nissan Chemical America, Houston Tex. under the trade designations “CELNAX CX-Z210IP”, “CELNAX CX-Z300H” (in water), “CELNAX CX-Z401M” (in methanol), and “CELNAX CX-Z653M-F” (in methanol).

In order to reduce or eliminate optical fringing on high refractive index substrates such as polyester or polycarbonate, it is preferred that the primer composition is formulated to closely match the refractive index of the high refractive index layer. In such embodiments, the primer composition differs from the high refractive index layer by less than 0.05, and more preferably by less than 0.02. When the optical display or film substrate also has a high refractive index (e.g. of at least 1.60), the refractive index of the primer composition also differs from the substrate by less than 0.05, and more preferably less than 0.02. However, when the substrate has a low refractive index, the difference in refractive index between the high refractive index layer and the substrate can range from about 0.05 to 0.10 and greater. For this embodiment, it is not possible to concurrently match the refractive index of the primer to both the high refractive index layer and the (i.e. low refractive index) substrate. In this embodiment, optical fringing is reduced or eliminated by formulating the primer to have a refractive index intermediate (i.e. median +/−0.02) between the low refractive index substrate and the high refractive index layer.

The refractive index of the sulfopolyester is typically about 1.5˜1.6. To raise the refractive index as just described, particles having a higher refractive index than the sulfopolyester are combined with the sulfopolyester. In some embodiments, such as when antimony tin oxide (ATO) is employed, the same particles provide static dissipative properties concurrently with raising the refractive index of the primer. However, for embodiments wherein the antistatic agent is a conductive polymer or a conductive inorganic oxide particle having a low refractive index, high refractive index non-conductive inorganic oxide particles can be added. Antistatic primers comprising sulfonated polymer binder, conductive polymer antistatic agent, and high index non-conductive nanoparticles, also provide primers free of heavy metals such as antimony and indium, while providing good antistatic and optical properties.

Various high refractive index particles are known including for example zirconia (“ZrO₂”), titania (“TiO₂”), antimony oxides, alumina, tin oxides, alone or in combination. Mixed metal oxide may also be employed. The refractive index of the high refractive index particles is at least 1.60, 1.65, 1.70, 1.75, 1.80, 1.85, 1.90, 1.95, or 2.00.

Zirconias for use in the high refractive index layer are available from Nalco Chemical Co. under the trade designation “Nalco OOSSOO8” and from Buhler AG Uzwil, Switzerland under the trade designation “Buhler zirconia Z-WO sol”. Zirconia nanoparticles can also be prepared such as described in U.S. patent application Ser. No. 11/027,426 filed Dec. 30, 2004 and U.S. Pat. No. 6,376,590.

The concentration of high refractive index non-conductive nanoparticle is typically no greater than 80 wt-% solids of the dried film. In some embodiments, it is preferred to include 35 to 70 wt-% solids of high refractive index nanoparticles.

In some embodiments, it is preferred to surface treat the conductive and/or non-conductive nanoparticles so that the particles will be well dispersed in the antistatic (e.g. primer) composition resulting in a substantially homogeneous composition. In general, the surface treatment agent has a first end that will attach to the particle surface (covalently, ionically or through strong physisorption) and a second end that imparts compatibility of the particle with the (e.g. sulfopolyester) sulfopolymer. Examples of surface treatment agents include alcohols, amines, carboxylic acids, sulfonic acids, phosphonic acids, silanes and titanates. The preferred type of treatment agent is determined, in part, by the chemical nature of the metal oxide surface. Silanes and carboxylic acids are preferred for metal oxides such as zirconia. The surface modification can be done either subsequent to mixing with the monomers or after mixing. The required amount of surface modifier is dependent upon several factors such as particle size, particle type, modifier molecular weight, and modifier type. In general, it is preferred that about a monolayer of modifier be attached to the surface of the particle.

When surface treating conductive particles, the kind and/or amount of surface treatment is chosen such that the surface treatment does not hinder the static dissipative properties contributed by the antistatic particles. The Applicant has found that amino alcohol compounds such as triethanolamine are preferred surface treatments, particularly for antimony tin oxide antistatic particles.

Additives such as rheology modifier(s), flow agent(s), leveling agent(s), anti-foamer(s), anti-skinning agent(s), surfactants and various preservatives such as biocides are also typically included in the aqueous antistatic compositions at small concentrations. Examples of suitable surfactants include nonionic surfactants such as the branched secondary alcohol ethoxylates available as Tergitol™ surfactants from Dow Chemical Co., and primary alcohol ethoxylates such as Tomadol® 25-9 from Tomah Chemical Co.

The sulfopolymer dispersion and antistatic agent dispersion are mixed together. Generally, this involves stirring the two dispersions together for sufficient time to effect complete mixing. When the antistatic agent is a conductive polymer such as Baytron P, a solvent such as ethylene glycol, DMF (dimethyl formamide), DMSO (dimethyl sulfoxide), or 1-methyl-2-pyrrolidinone can be added to the conductive polymer solution to improve conductivity of the dried coating. If other non-conductive high index particles or additives are to be incorporated into the coating mixture, however, it is frequently more convenient to stir the mixture for several hours by placing the mixture into a glass jar containing several glass beads and roll milling it. Surfactants can be added at the mixing step. Any water compatible surfactant, except those of high acidity or basicity or complexing ability, or which otherwise would interfere with the desired product, is suitable for the practice of this invention.

The antistatic coating formulation may be water- or solvent-based, although water-based is typically preferred. In general, the antistatic layer may be formed by coating the antistatic coating formulation onto the light transmissive substrate. A high refractive index layer is disposed on the antistatic primer. When forming an antireflective article, a low index layer is coupled to the high refractive index layer.

The high refractive index layer and low refractive index composition can be applied as a single or multiple layers directly to a (e.g. display surface or film) substrate using conventional film application techniques. A combination of low reflectance and good durability can be obtained with a single low refractive index layer provided on a single high refractive index layer.

Thin films of the antistatic primer, high refractive index layer, and low refractive index layer can be applied using a variety of techniques, including dip coating, forward and reverse roll coating, wire-wound rod coating, spin coating, and die coating. Die coaters include knife coaters, slot coaters, slide coaters, fluid bearing coaters, slide curtain coaters, drop die curtain coaters, and extrusion coaters among others. Many types of die coaters are described in the literature such as by Edward Cohen and Edgar Gutoff, Modern Coating and Drying Technology, VCH Publishers, NY 1992, ISBN 3-527-28246-7 and Gutoff and Cohen, Coating and Drying Defects: Troubleshooting Operating Problems, Wiley Interscience, NY ISBN 0-471-59810-0.

Typically, the high index layer and low index layer are sequentially applied and cured to crosslink polymerizable components therein. Alternatively, these layers may be concurrently applied. The low and high refractive index coating compositions are dried in an oven to remove the solvent and then cured for example by exposure to ultraviolet radiation using an H-bulb or other lamp at a desired wavelength, preferably in an inert atmosphere (less than 50 parts per million oxygen). The reaction mechanism causes the free-radically polymerizable materials to crosslink. Alternatively, the high and low refractive index coating may be applied to a release liner, at least partially cured, and transfer coated.

Durable antireflective films generally comprise a relatively thick high refractive index layer in combination with a relatively thin low refractive index layer. The high refractive index layer typically has a thickness of at least 0.5 microns, preferably at least 1 micron, more preferably at least 2 microns. The high refractive index layer typically has a thickness of no greater than 10 microns and more typically no greater than 5 microns. The low refractive index layer has an optical thickness of about ¼ wave. Such thickness is typically less than 0.5 microns, more typically less than about 0.2 microns and often about 90 nm to 110 nm. When a durable high refractive index layer is employed in combination with a durable low refractive index layer, a durable (e.g. two-layer) antireflective film can be provided in the absence of additional hardcoat layers.

The low and high refractive index layers comprise the reaction product of free-radically polymerizable materials such as those having polymerizable (meth)acrylate groups. The high refractive index layer comprises surface modified nanoparticles having a high refractive index dispersed in a crosslinked organic material.

The low refractive index surface layer comprises the reaction product of a polymerizable low refractive index composition comprising at least one fluorinated free-radically polymerizable material and surface modified inorganic nanoparticles having a low refractive index (e.g. less than 1.50). Various low refractive index inorganic particles are known such as metal oxides, metal nitrides, and metal halides (e.g. fluorides). Preferred low refractive index particles include colloidal silica, magnesium fluoride, and lithium fluoride. Silicas for use in the low refractive index composition are commercially available from Nalco Chemical Co., Naperville, Ill. under the trade designation “Nalco Collodial Silicas” such as products 1034a, 1040, 1042, 1050, 1060, 2327 and 2329. Suitable fumed silicas include for example, products commercially available from DeGussa AG, (Hanau, Germany) under the trade designation, “Aerosil series OX-50”, as well as product numbers -130, -150, and -200. Fumed silicas are also commercially available from Cabot Corp., Tuscola, Ill., under the trade designations “CAB-O—SPERSE 2095”, “CAB-O-SPERSE A105”, and “CAB-O-SIL M5”. The silica nanoparticles are preferably surface modified with an organosilane compound such as an aminosilane.

The fluorinated component(s) of the low refractive index layer provide low surface energy. The surface energy of the low index coating composition can be characterized by various methods such as contact angle and ink repellency. The static contact angle with water of the cured low refractive index layer is typically at least 80°. More preferably, the contact angle is at least 90° and most preferably at least 1100. Alternatively, or in addition thereto, the advancing contact angle with hexadecane is at least 50° and more preferably at least 60°. Low surface energy is amenable to anti-soiling and stain repellent properties as well as rendering the exposed surface easy to clean.

In some aspects, the durable antireflective films resist scratching after repeated contact with an abrasive material such as steel wool. The presence of significant scratching can increase the haze of the antireflective film. In one embodiment, the antireflective film has a haze of less than 1.5% or 1.0% after 5, 10, 15, 20, or 25 wipes with steel wool using a 3.2 cm mandrel and a mass of 1000 g, according to the Steel Wool Durability Test as described in FN62140; incorporated herein by reference.

Surface layers that resist visible scratching do not necessarily retain their low surface energy. In preferred embodiments, the antireflective films also retain low surface energy after repeated contact with an abrasive material such as steel wool. In preferred embodiments, the antireflective film preferably exhibits an advancing contact angle with hexadecane of at least 45°, 50°, or 60° after 5, 10, 15, 20, or 25 wipes with steel wool using a 3.8 cm diameter mandrel and a mass of 1000 grams. The antireflective film typically also exhibits a static contact angle with water of at least 90°, 95°, or 100° after 10 wipes, 50 wipes, 100 wipes, 200 wipes, or even 300 wipes with steel wool using a 3.8 cm diameter mandrel and a mass of 500 grams.

The high refractive index layer comprises surface modified nanoparticles (preferably having a high refractive index of at least 1.60) dispersed in a crosslinked organic material. A variety of (e.g. non-fluorinated) free-radically polymerizable monomers, oligomers, polymers, and mixtures thereof can be employed in the organic material of the high refractive index layer. Preferably the organic material of the high refractive index layer comprises a non-fluorinated free-radically polymerizable material having three or more (meth)acrylate groups alone or in combination with non-fluorinated monofunctional and/or difunctional materials.

The concentration of (e.g. inorganic) nanoparticles in the low refractive index layer and/or the high refractive index layer is typically at least 5 vol-%, and preferably at least 15 vol-%. The concentration of inorganic particles is typically no greater than about 50 vol-%, and more preferably no greater than 40 vol-%. The inorganic nanoparticles in the low refractive index and/or high refractive index layer are preferably surface modified.

The surface modified colloidal nanoparticles of the high and/or low refractive index layer can be substantially fully condensed. Non-silica-containing fully condensed nanoparticles typically have a degree of crystallinity (measured as isolated metal oxide particles) greater than 55%, preferably greater than 60%, and more preferably greater than 70%. For example, the degree of crystallinity can range up to about 86% or greater. The degree of crystallinity can be determined by X-ray diffraction techniques. Condensed crystalline (e.g. zirconia) nanoparticles have a high refractive index whereas amorphous nanoparticles typically have a lower refractive index.

The inorganic particles preferably have a substantially monodisperse size distribution or a polymodal distribution obtained by blending two or more substantially monodisperse distributions. Alternatively, the inorganic particles can be introduced having a range of particle sizes obtained by grinding the particles to a desired size range. The inorganic oxide particles are typically non-aggregated (substantially discrete), as aggregation can result in optical scattering (haze) or precipitation of the inorganic oxide particles or gelation. The inorganic oxide particles are typically colloidal in size, having an average particle diameter of 5 nanometers to 100 nanometers. The particle size of the high index inorganic particles is preferably less than about 50 nm in order to provide sufficiently transparent high-refractive index coatings. The average particle size of the inorganic oxide particles can be measured using transmission electron microscopy to count the number of inorganic oxide particles of a given diameter.

The antireflective film may have a gloss or matte surface. Matte antireflective films typically have lower transmission and higher haze values than typical gloss films. For examples the haze is generally at least 5%, 6%, 7%, 8%, 9%, or 10% as measured according to ASTM D1003. Whereas gloss surfaces typically have a gloss of at least 130 as measured according to ASTM D 2457-03 at 60°, matte surfaces have a gloss of less than 120.

The surface can be roughened or textured to provide a matte surface. This can be accomplished in a variety of ways as known in the art including embossing the low refractive index surface with a suitable tool that has been bead-blasted or otherwise roughened, as well as by curing the composition against a suitable roughened master as described in U.S. Pat. Nos. 5,175,030 (Lu et al.) and 5,183,597 (Lu).

In yet another aspect, matte antireflective films can be prepared by providing the high refractive index layer and low refractive index (e.g. surface) layer on a matte film substrate. Exemplary matte films are commercially available from U.S.A. Kimoto Tech, Cedartown, Ga. under the trade designation “N4D2A.”

Matte low and high refractive index coatings can also be prepared by adding a suitably sized particle filler such as silica sand or glass beads to the composition. Such matte particles are typically substantially larger than the surface modified low refractive index particles. For example the average particle size typically ranges from about 1 to 10 microns. The concentration of such matte particles may range from at least 2 wt-% to about 10 wt-% or greater. At concentrations of less than 2 wt-% (e.g. 1.8 wt-%, 1.6 wt-%, 1.4 wt-%, 1.2 wt-%, 1.0 wt-%, 0.8 wt-%, 0.6 wt-%, the concentration is typically insufficient to produce the desired reduction in gloss (which also contributes to an increase in haze). However, durable antireflective films can be provided in the absence of such matte particles.

The low refractive index polymerizable composition and organic high refractive index polymerizable composition generally comprise at least one crosslinker having at least three free-radically polymerizable groups. This component is often a non-fluorinated multi-(meth)acrylate monomer. The inclusion of such material contributes to the hardness of the cured compositions.

The low refractive index and organic high refractive index polymerizable compositions typically comprise at least 5 wt-%, or 10 wt-%, or 15 wt-% of crosslinker. The concentration of crosslinker in the low refractive index composition is generally no greater than about 40 wt-%. For preferred embodiments that employ high concentration of inorganic particles, the concentration of crosslinker in the high refractive index composition is generally no greater than about 25 wt-%.

Suitable monomers include for example trimethylolpropane triacrylate (commercially available from Sartomer Company, Exton, Pa. under the trade designation “SR351”), ethoxylated trimethylolpropane triacrylate (commercially available from Sartomer Company, Exton, Pa. under the trade designation “SR454”), pentaerythritol tetraacrylate, pentaerythritol triacrylate (commercially available from Sartomer under the trade designation “SR444”), dipentaerythritol pentaacrylate (commercially available from Sartomer under the trade designation “SR399”), ethoxylated pentaerythritol tetraacrylate, ethoxylated pentaerythritol triacrylate (from Sartomer under the trade designation “SR494”) dipentaerythritol hexaacrylate, and tris(2-hydroxy ethyl) isocyanurate triacrylate (from Sartomer under the trade designation “SR368”). In some aspects, a hydantoin moiety-containing multi-(meth)acrylate compound, such as described in U.S. Pat. No. 4,262,072 (Wendling et al.) is employed.

The low refractive index layer preferably comprises one or more free-radically polymerizable materials having a fluorine content of at least 25 wt-%. Highly fluorinated monomer, oligomers, and polymers are characterized by having a low refractive index. Various fluorinated multi- and mono-(meth)acrylate materials having a fluorine content of at least about 25 wt-% are known. In some embodiments, the low refractive index polymerizable composition has a fluorine content of at least 30 wt-%, at least 35 wt-%, at least 40 wt-%, at least 45 wt-%, or at least 50 wt-%. Typically, a major portion of the highly fluorinated material is a multifunctional free-radically polymerizable material. However, such materials can be used in combination with fluorinated mono-functional materials.

Various fluorinated mono- and multi-(meth)acrylate compounds may be employed in the preparation of the polymerizable low refractive index coating composition. Such materials generally comprise free-radically polymerizable moieties in combination with (per)fluoropolyether moieties, (per)fluoroalkyl moieties, and (per)fluoroalkylene moieties. Within each of these classes are species having a high fluorine content, (e.g. of at least 25 wt-%).

In some embodiments, the free radically polymerizable perfluoropolyether comprises HFPO-moieties. “HFPO-” refers to the end group F(CF(CF₃)CF₂O)ₐCF(CF₃)— derived from the methyl ester F(CF(CF₃)CF₂O)ₐCF(CF₃)C(O)OCH₃, wherein a averages 2 to 15. In some embodiments, a averages between 3 and 10 or a averages between 5 and 8. Such species generally exist as a distribution or mixture of oligomers with a range of values for a, so that the average value of a may be non-integer. In one embodiment, a averages 6.2. For example, perfluoropolyether urethane compounds may be employed such as described in U.S. patent application Ser. No. 11/087,413, filed Mar. 23, 2005 and U.S. application Ser. No. 11/277,162, filed Mar. 22, 2006.

In preferred embodiments, the low refractive index polymerizable composition comprises at least one free-radically polymerizable fluoropolymer.

Preferred fluoropolymers are formed from the constituent monomers known as tetrafluoroethylene (“TFE”), hexafluoropropylene (“HFP”), and vinylidene fluoride (“VDF,” “VF2,”). The monomer structures for these constituents are shown below:

TFE:CF₂═CF₂ (1)

VDF:CH₂═CF₂ (2)

HFP:CF₂═CF—CF₃ (3)

The fluoropolymers preferably comprise at least two of the constituent monomers (HFP and VDF), and more preferably all three of the constituent monomers in varying molar amounts.

The fluoropolymer comprises free-radically polymerizable groups. This can be accomplished by the inclusion of halogen-containing cure site monomers (“CSM”) and/or halogenated endgroups, which are interpolymerized into the polymer using numerous techniques known in the art. These halogen groups provide reactivity towards the other components of the coating mixture and facilitate the formation of the polymer network. Optionally, halogen cure sites can be introduced into the polymer structure via the use of halogenated chain transfer agents which produce fluoropolymer chain ends that contain reactive halogen endgroups. Such chain transfer agents (“CTA”) are well known in the literature and typical examples are: Br—CF₂CF₂—Br, CF₂Br₂, CF₂I₂, CH₂I₂.

The fluoropolymer-containing low refractive index compositions described herein preferably comprise at least one amino organosilane ester coupling agent or a condensation product thereof as described in Ser. No. 11/026,640, filed Dec. 30, 2004; incorporated herein by reference.

In another embodiment, the low refractive index layer comprises the reaction product of a A) fluoro(meth)acrylate polymeric intermediate and B) at least one fluorinated (meth)acrylate monomer as described in U.S. application Ser. No. 11/423,791, filed Jun. 13, 2007; incorporated herein by reference.

At least one free-radical initiator is typically utilized for the preparation of the polymerizable low and high refractive index coating compositions. Useful free-radical thermal initiators include, for example, azo, peroxide, persulfate, and redox initiators, and combinations thereof. Useful free-radical photoinitiators include, for example, those known as useful in the UV cure of acrylate polymers. In addition, other additives may be added to the final composition. These include but are not limited to resinous flow aids, photostabilizers, high boiling point solvents, and other compatibilizers well known to those of skill in the art.

The polymerizable compositions can be formed by dissolving the free-radically polymerizable material(s) in a compatible organic solvent at a concentration of about 1 to 10 percent solids. A single organic solvent or a blend of solvents can be employed.

The optical and antireflective films described herein are suitable for application to optical displays (“displays”). The displays include various illuminated and non-illuminated display panels. Such displays include multi-character and especially multi-line multi-character displays such as liquid crystal displays (“LCDs”), plasma displays, front and rear projection displays, cathode ray tubes (“CRTs”), signage, as well as single-character or binary displays such as light emitting tubes (“LEDs”), signal lamps and switches.

The optical and antireflective films can be employed with a variety of portable and non-portable information display articles. These articles include, but are not limited to, PDAs, LCD-TV's (both edge-lit and direct-lit), cell phones (including combination PDA/cell phones), touch sensitive screens, wrist watches, car navigation systems, global positioning systems, depth finders, calculators, electronic books, CD and DVD players, projection television screens, computer monitors, notebook computer displays, instrument gauges, and instrument panel covers. These devices can have planar or curved viewing faces.

The optical and antireflective films can be employed on a variety of other articles as well such as for example camera lenses, eyeglass lenses, binocular lenses, mirrors, retroreflective sheeting, automobile windows, building windows, train windows, boat windows, aircraft windows, vehicle headlamps and taillights, display cases, eyeglasses, overhead projectors, stereo cabinet doors, stereo covers, watch covers, as well as optical and magneto-optical recording disks, and the like.

The antireflective film may also be applied to a variety of other articles including (e.g. retroreflective) signage and commercial graphic display films employed for various advertising, promotional, and corporate identity uses.

While the invention has been described in terms of preferred embodiments, it will be understood, of course, that the invention is not limited thereto since modifications may be made by those skilled in the art, particularly in light of the foregoing teachings.

### EXAMPLES

### Test Methods

The following tests were performed to evaluate the adhesion, antistatic efficacy, and optical properties of the optical films and antireflective films.

### 1. Cross-Hatch Adhesion

Using a razor blade, three cross-hatch patterns of squares were generated, over which 3M Scotch 810 was applied. The tape was pulled rapidly, and the percent adhesion was quantified by the amount of coating removed from the squares in the cross-hatch patterns. Three separate areas on a single film were tested. The adhesion was rated on a scale of 0 to 5, where 0 means 100% coating was removed, while 5 means 0% coating was removed.

### 2. Antistatic Efficiency Measurements

Static charge decay time was measured using an Electro-Tech Systems, Inc. Model 406C (Glenside, Pa.) static decay meter by charging the sample to +5 kV and measuring the time required for the static charge to decay to 10% of its initial value. Film samples approximately five inches on a side were cut and mounted between the meter electrodes using magnets. Static charge decay tests were performed on three parallel film samples, reporting the average decay time.

3. Surface Resistance Measurements were performed using a ProStat (Bensenville, Ill.) PRS-801 resistance system equipped with a PRF-911 concentric ring fixture. Output values in ohms were converted to ohms/sq by multiplying the measured values by 10 according to the documentation supplied with the instrument. Surface resistivity and static charge decay measurements were made at ambient laboratory humidity of 30-40%. Three measurements were taken on a single film substrate, reporting the average measurement.

### 4. Optical Property Measurements

The haze (% H) and transmission (% T) were measured using a Haze-Gard Plus (BYK-Gardner USA, Columbia, Md.). The reflection spectra were measured using a Lambda 900 UV/Vis/NIR spectrometer (Perkin Elmer, Waltham, Mass.). The reflection spectrum is a single measurement recorded by the spectrometer.

### Sulfopolymer Primer Base Compositions

A water-soluble Sulfopolyester Polymer (SP-1) at about 20% solids, was prepared according to Example 5 (Polymer D) of U.S. Pat. No. 5,427,835. The Tg of SP-1 is reported to be 70.3° C. by differential scanning calorimetry (DSC).

A water-soluble Sulfopolyester Polymer (SP-2) at about 20% solids, was prepared according to Example 3 (Polymer A) of U.S. Pat. No. 5,427,835. The Tg of SP-2 is reported to be 50.1° C. by differential scanning calorimetry (DSC).

To prepare Sulfopolyester Primers A-C, DI water, SP-1 or SP-2, and Tomadol 25-9 surfactant in the concentration indicated as follows were mixed together under stirring. Then the indicated croslinker was added to the mixture under rapid stirring, resulting in a homogeneous primer solution.

### Sulfopolyester Primer A:

| | | | Wt-% | |
|---|---|---|---|---|
| Generic Chemical | Trade | Supplier | Solids as | Wt-% of |
| Description | Designation | (Location) | supplied | Component |
| Sulfopolyester | | | 20 | 8.7 |
| Polymer SP-1 | | | | |
| Polyfunctional | Neocryl CX- | DSM | 100 | 0.32 |
| Aziridine | 100 | NeoResins | | |
| Crosslinker | | Inc | | |
| Ethoxylated | Tomadol 25-9 | Tomah | 10 | 0.68 |
| C12–C15 | | Products, | | |
| Alcohols Wetting | | Inc. | | |
| Agent | | | | |
| | DI Water | | 0 | 64.5 |
| | Total | | | 74.2 |

### Sulfopolyester Primer B:

| | Wt-% | |
|---|---|---|
| Materials | Solids | Component (g) |
| Sulfopolyester Polymer SP-1 | 20 | 30.6 |
| XR 5577 crosslinker | 40 | 2.00 |
| Tomadol 25-9 | 10 | 1.46 |
| DI Water | 0 | 133.94 |
| Total | | 168.00 |

### Sulfopolyester Primer C:

| | Wt-% | |
|---|---|---|
| Materials | Solids | Component (g) |
| Sulfopolyester Polymer (SP-2) | 20 | 30.6 |
| γ-glycidoxypropyl- | 5 | 12.24 |
| trimethoxysilane crosslinker | | |
| Tomadol 25-9 | 10 | 0.86 |
| DI Water | 0 | 124.64 |
| Total | | 168.34 |

### Example 1

### Conductive (ATO) Particles Surface Modified w/Amino Alcohol Compound

A dilute solution was formed by mixing together with stirring 0.85 g of triethanolamine (TEOA) and 20.47 g of DI water. Then 21.32 g of 30 nm ATO IPA sol (30 nm, 30 wt-% solids available from Advanced Nano Products Co. Ltd. (ANP), Chungcheongbuk-Do, Korea) was added under rapid stirring. The mixture was further stirred for another 1 h to form a stable 15 wt-% TEOA Surface Modified ATO sol with a low viscosity that was stored at room temperature.

### Comparative Example A

5 g of SP-1 solution and 1.25 g of 30 nm ATO IPA sol were mixed together, which immediately resulted in formation of a blue precipitate. Further stirring or ultrasonic treatment did not dissolve the precipitate to form a homogeneous solution. The results show that this particular combination of sulfopolyester and conductive nanoparticles does not form a compatible coating solution.

### Antistatic Primer 1—Sulfopolyester and Surface Modified Conductive Particles

33.2 g of 15 wt-% TEOA Surface Modified ATO Sol was added to 60 g of Sulfopolyester Primer A solution while stirring. This resulted in a dark blue primer coating solution.

### Antistatic Primer 2—Sulfopolyester, Conductive Polymer, and High Refractive Index (SnO₂) Particles

100 g of Sulfopolyester Primer B was prepared as described above. Then 31.2 g Baytron P (wt-% solution as supplied) and 50 g of a 10-15 nm SnO₂ nanoparticle dispersion (15 wt-% in water supplied by Nyacol Nano Technologies, Inc) was added under stirring, resulting in a homogeneous blue primer solution. The weight ratio (PEDOT/PSS):SP-1:SnO₂ was approximately 1:9:18.6.

### Antistatic Primer 3—Sulfopolyester, Conductive Polymer, and High Refractive Index (TiO₂) Particles

100 g of Sulfopolyester Primer B solution was prepared as described above. Then 31.2 g of Baytron P (1.3 wt-% solution as supplied) and 35 g of 7 nm rutile TiO₂ (10 wt-% supplied by Applied NanoWorks, Watervliet, N.Y.) was added under stirring, resulting in a homogeneous blue primer solution. The weight ratio of (PEDOT:/PSS):SP-1:TiO₂ was about 1:9:8.63.

### Antistatic Primer 4—Sulfopolyester and Conductive Polymer

168.34 g Sulfopolyester Primer C solution was prepared as described above. Then 52.2 g Baytron P (1.3% wt solution as supplied) was added under stirring, resulting in a homogeneous blue primer solution. The PEDOT/PSS content was about 10% of the total solids.

### Antistatic Primer 5—Sulfopolyester and Conductive Polymer

0.8 g DMSO was added to 16 g Baytron P solution with stirring at room temperature overnight. Then, 100 g Sulfopolyester Primer C solution was added resulting in a homogeneous blue primer solution. The PEDOT/PSS content was about 5% of the total solids.

### Antistatic Primer 6—Sulfopolyester and High Refractive Index (ATO) Conductive Particles

168.34 g of Sulfopolyester Primer C solution was prepared as described above. Then 45.8 g of the 30 nm ATO sol (ANP) was added under stirring, resulting in a homogeneous blue primer solution.

### Antistatic Primer 7—Sulfopolyester and High Refractive Index (ATO) Conductive Particles

168.34 g of Sulfopolyester Primer C solution was prepared as described above. Then 35.6 g of 30 nm ATO sol (ANP) and 15.2 g of 100 nm ANP ATO sol (20 wt-% in water, obtained from ANP, Korea) were added under stirring, resulting in a homogeneous blue primer solution.

### Antistatic Primer 8—Sulfopolyester and Conductive Particles

100 g of Sulfopolyester Primer C solution was prepared as described above. Then 31.25 g 20 wt-% AZO in IPA dispersion (“CELNAX CX-Z210IP) was added under stirring, resulting in a homogeneous blue-green primer solution.

High index hardcoat (HIHC) coating solution was prepared according to US 20060147674. Briefly, 94.1 g of dipentaerythritol pentaacrylate (SR 399, Sartomer, Exton, Pa.), 16.1 g of Irgacure 184, and 246.6 g of MEK were added to a 2 L container. The mixture was stirred until homogenous. Then 735.1 g of 3-(methacryloyloxy)propyltrimethoxysilane modified zirconia sol (59.2% wt in methoxypropanol) was added slowly to the mixture and gently mixed, resulting in a homogenous coating solution.
Low Refractive Index coating solution was prepared from 10% solids masterbatch solutions of each of the component described below.

40 wt-% of a fluoropolymer commercially available from Dyneon LLC of St. Paul, Minn. under the trade designation Dyneon FPO 3749;

35 wt-% of surface modified silica nanoparticles prepared according to the method described in WO2006073867A Example 4, where 3-(methacryloyloxy) propyltrimethoxysilane and hexamethyldisilizane were used.

20 wt-% of a dipentaerythritol pentaacrylate (molecular weight of 525 g/mole) obtained from Sartomer Company, Exton, Pa. under the trade designation “SR-399”,

5 wt-% an oligomerized product of gamma-aminopropyl trimethoxysilane, available from GE Silicones of Parkersberg, W. Va. under the trade designation “A-1106” (25 wt-% solids solution in methanol.)

1.5 wt-% of a KB-1” benzyl dimethyl ketal UV photoinitiator obtained from Sartomer Company under the trade designation “KB-1”.

The component solutions were mixed to obtain the weight ratios listed in the tables below. The reagents were mixed in amber bottles to enhance the storage stability of the formulations. The low index reagent was added first followed by further dilution to 5% solids with MEK. The remaining reagents were then added to this component. Finally, the solution was diluted with MEK to obtain the desired percents solids and coated within 48 hours of being prepared.

Antistatic primer compositions 1-3 are suitable for PET. These antistatic primers are also believed suitable for PC substrates provided that the concentration of wetting agents is increased. Antistatic primer compositions 4-8 are suitable for substrate having a low refractive index including TAC substrates.

### Preparation of Optical Films Comprising PET Substrate, Antistatic Primer 1, and High Refractive Index Layer

Antistatic Primer 1 and Sulfopolyester Primer A were applied onto unprimed side of PET film obtained from DuPont under the trade designation “Melinex 618”. The primer coating solutions were syringe-pumped into a 4-inch wide coating die, and the coating was dried by passing through two 10 feet ovens. Further details of the process conditions are included in the table below.

| | Line | Syringe | | |
|---|---|---|---|---|
| | Speed | Flow Rate | Oven | Oven |
| | (fpm) | (cc/min) | (° C.) | (° C.) |
| Antistatic | 10 | 4.50 | 120 | 120 |
| Primer 1 | | | | |
| Sulfopolymer | 10 | 2.42 | 120 | 120 |
| Primer A | | | | |

The HIHC was then coated and dried onto the primer in the same manner. The HIHC coatings were then cured with a Light Hammer 6 UV source (Fusion UV Systems, INC. Gaithersburg, Md.) under nitrogen. Further details of the process conditions are included in the table below.

| Line | Syringe | | | | | |
|---|---|---|---|---|---|---|
| Speed | Flow Rate | Oxygen | | % | Oven | Oven |
| (fpm) | (cc/min) | ppm | Bulb | UV | (° C.) | (° C.) |
| 30 | 2.7 | 2.12 | H | 100 | 80 | 80 |

Measurement of the UV output of the UV lamp at 100% UV at a line speed of 10 feet/per/min resulted in the following energy and power readings for the UV A, B, C, and V regions. Accordingly, the coated PET substrate was exposed to ⅓ such UV-energy.

| UV-A | UV-B | UV-C | UV-V | Units |
|---|---|---|---|---|
| 1.63 | 1.60 | 0.21 | 0.99 | W/cm² |

### Preparation of Antireflective Films

The low refractive index coating solution was syringe-pumped into a 4-inc wide coating die, and the coating was dried by passing through two 10 feet ovens. The coatings were then cured with a Light Hammer 6 UV source (Fusion UV Systems, INC.) under nitrogen.

| | Syringe | | | | | |
|---|---|---|---|---|---|---|
| Line | Flow | | | | | |
| Speed | Rate | Oxygen | | % | Oven | Oven |
| (fpm) | (cc/min) | ppm | Bulb | UV | (° C.) | (° C.) |
| 10 | 1.78 | 1.1 | H | 100 | 80 | 80 |

Measurement of the UV output of the UV lamp at 100% UV at a line speed of 10 feet/per/min resulted in the following energy and power readings for the UV A, B, C, and V regions.

| UV-A | UV-B | UV-C | UV-V | Units |
|---|---|---|---|---|
| 1.63 | 1.60 | 0.21 | 0.99 | W/cm² |

TABLE 1
Optical Film Test Results

| | | Cross- | | Surface | Charge |
|---|---|---|---|---|---|
| Film Constructions with | | hatch | | Resistance | Decay |
| PET Film | | adhesion | Haze | (ohms/sq.) | Time (s) |
| 1. | Unprimed PET | | 0.6 | | WNC |
| 2. | PET/ | | 0.89 | | WNC |
| | Sulfopolyester | | | | |
| | Primer A | | | | |
| 3. | PET/Antistatic | | <1.6 | 0.2~8 × 10¹⁰ | <0.5 |
| | Primer 1 | | | | |
| 4. | PET/Antistatic | 4–5 | 0.5~1.0 | | 0.01~0.5 |
| | Primer 1/HIHC | | | | |
| 5. | PETAntistatic | 5 | 0.5~0.9 | | 0.01~0.5 |
| | Primer 1/HIHC/LIC | | | | |

WNC = Would Not Charge

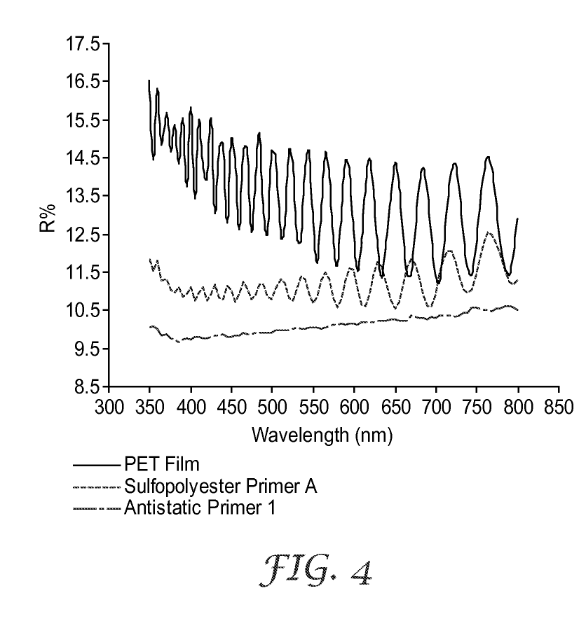

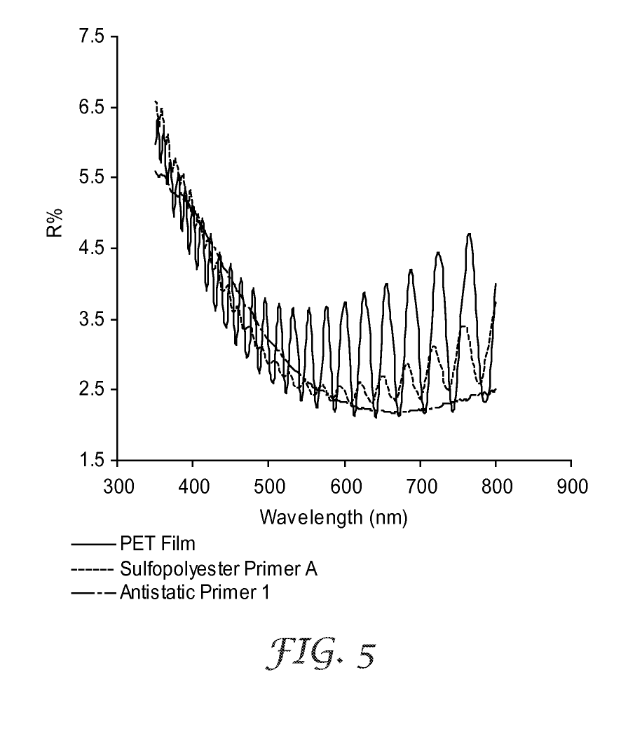

FIG. 4 is the reflection spectra of the Melinex 618 PET having the HIHC in comparison to the Melinex 618 PET having Sulfopolymer Primer A and the Melinex 618 PET having Antistatic Primer 1. The fringing amplitude around 550 nm was 3, 1.2 and, 0.08 respectively. FIG. 5 is the reflection spectra of three antireflective films further comprising the dried and cured low refractive index layer. The results show that antistatic primers described herein can reduce and eliminate optical fringing.

Preparation of Optical Films Comprising Antistatic Primers 2-8 and High Refractive Index layer

Antistatic Primer 2 and 3 were applied onto the unprimed side of “Melinex 618” PET using a #4 wire-wound rod (obtained from RD Specialties, Webster, N.Y.). The primer coated PET film was cured and dried at 100° C. for about 2 min.

Antistatic Primers 4-8 were coated on the inside of unhydrolyzed TAC film using a #4 wire-wound rod. The primer coated TAC films were cured and dried at about 80° C. in a forced-air oven for 0.5-3 min.

The HIHC solution was then applied on top of each of Antistatic Primers 2-8 using a #9 wire-wound rod. The resulting film was then dried in an oven 85° C. for 1˜2 min, then cured using a Fusion UVSystems Inc. LightHammer 6 UV (Gaithersburg, Md.) processor equipped with an H-bulb, operating under nitrogen atmosphere at 100% lamp power at a line speed of 30 feet/min (1 pass). The resulting high index coating layer had a thickness of about 4 microns.

For Antistatic Primer Composition 2, it was found that the addition of SnO₂ does not adversely affect the antistatic properties of the resulting primer coating. The surface resistance of primers on PET with and without SnO₂ was measured to be 6.8×10⁸ ohms/square and 1.4×10⁹ ohms/square, respectively. After applying HIHC, only very small interference fringing was detected by the UV-Vis-NIR spectrometer similar to that of the Antistatic Primer 1 as shown in FIG. 4.

### Preparation of Antireflective Films

Antireflective films were prepared by coating the dried and cured HIHC (having Antistatic Primers 2-8) with the low index coating previously described using #3 wire-wound rod and a 5 wt-% solids solutions. The resulting dry coating thickness was approximately 90 nm. Then, the films were cured using a Fusion UVSystems Inc. LightHammer 6 UV processor equipped with an H-bulb, operating under nitrogen atmosphere at 100% lamp power and a line speed of 20 feet/min (2 pass).

Thus, Antistatic Primers 1 and 2 are preferred primers for PET because such primers provide antistatic performance in combination with refractive index matching to both the PET film and HIHC, resulting in minimal optical fringing and improving optical uniformity.

Antistatic Primers 6 and 7 are preferred primers for TAC because such primers provide antistatic performance in combination with an intermediate refractive index relative to the TAC film and HIHC, resulting in minimal optical fringing and improving optical uniformity.

TABLE 2
Optical Film Test Results

| | Surface | | |
|---|---|---|---|
| Film Construction with | Resistance | Cross-Hatch | |
| TAC Film | (ohms/sq) | Adhesion | Charge Decay (s) |
| TAC/Sulfopolyester | | Pass | DNW |
| Primer C/HIHC | | | |
| TAC/Antistatic Primer | 7.2 × 10⁸ | Pass | <0.01 |
| 4/HIHC | | | |
| TAC/Antistatic Primer | 3.4 × 10⁸ | Pass | 0.01 |
| 5/HIHC | | | |
| TAC/Antistatic Primer | 5.7 × 10⁸ | Pass | 0.01 |
| 6/HIHC | | | |
| TAC/Antistatic Primer | 1.8 × 10⁹ | Pass | 0.01 |
| 7/HIHC | | | |
| TAC/Antistatic Primer | 1.0 × 10¹⁰ | Pass | 0.01 |
| 8/HIHC | | | |

WNC = Would Not Charge

What is claimed:

1. An optical article comprising
a light transmissive substrate;
an antistatic primer disposed on the substrate wherein the primer comprises a sulfopolymer and at least one antistatic agent; and
a high refractive index layer having a refractive index of at least 1.60 disposed on the primer wherein the high refractive index layer comprises surface modified inorganic nanoparticles dispersed in a crosslinked organic material.

2. The optical film of claim 1 wherein the antistatic agent is selected from conductive inorganic particles, conductive polymer, and mixtures thereof.

3. The optical film of claim 1 wherein the article has a static charge decay time of less than 0.5 seconds.

4. The optical film of claim 1 wherein the sulfonated polymer comprises a sulfopolyester.

5. The optical film of claim 2 wherein the conductive inorganic particles have a refractive index of at least 1.90.

6. The optical film of claim 5 wherein the conductive inorganic oxide particles comprise antimony tin oxide.

7. The optical film of claim 1 wherein the antistatic primer comprises a sulfopolymer, a conductive polymer, and non-conductive inorganic oxide particles having a refractive index greater than the sulfopolymer wherein the antistatic primer has a refractive index of at least 1.60.

8. The optical film of claim 7 wherein the high refractive index particles are selected from the group consisting of tin oxide, titania, zirconia, and mixtures thereof.

9. The optical film of claim 1 wherein the substrate has a refractive index of at least 1.55.

10. The optical film of claim 9 wherein the substrate comprises a polyester.

11. The optical film of claim 9 wherein the primer has a refractive index that is +/−0.05 of both the refractive index of the substrate and refractive index of the high refractive index layer.

12. The optical film of claim 1 wherein the substrate has a refractive index that differs from the high refractive index layer by at least +/−0.10 and the primer has an intermediate refractive index.

13. The optical film of claim 12 wherein the substrate comprises cellulose acetate.

14. The optical film of claim 1 wherein the optical film is an antireflective film further comprising a low refractive index layer disposed on the high refractive index layer.

15. The optical film of claim 2 wherein the conductive inorganic particles comprise a surface treatment.

16. An antistatic composition comprising a sulfopolymer, a conductive polymer, and inorganic oxide particles having a refractive index greater than the sulfopolymer wherein the antistatic primer has a refractive index of at least 1.60.

17. The antistatic composition of claim 16 wherein the high refractive index particles are selected from the group consisting of tin oxide, titania, zirconia, and mixtures thereof.

18. A polymeric film having a refractive index of at least 1.60 comprising a coated surface comprising the antistatic composition of claim 16.

19. An antistatic composition comprising a sulfopolymer and conductive inorganic oxide particles having a surface treatment consisting of a polar organic compound.

20. The antistatic composition of claim 19 wherein the sulfopolymer comprises a sulfopolyester.

21. The antistatic composition of claim 19 wherein at least a portion of the conductive inorganic particles have a refractive index of at least 1.90.

22. The antistatic composition of claim 19 wherein the surface treatment comprises an amine.

23. The antistatic composition of claim 22 wherein the surface treatment comprises one or more —OH groups.

24. The antistatic composition of claim 23 wherein the surface treatment comprises triethanolamine.

25. A polymeric film comprising a coated surface comprising the antistatic composition of claim 19.

26. Conductive inorganic oxide particles surface treated with a surface treatment comprising an amino alcohol compound.

27. The conductive inorganic oxide particles of claim 26 wherein the particles comprise antimony tin oxide.

28. The conductive inorganic oxide particles of claim 26 wherein the surface treatment comprises triethanolamine.
